(19) United States
(12) Patent Application Publication
(10) Pub. No.: US 2014/0022922 A1
(43) Pub. Date: Jan. 23, 2014

(54) COMMUNICATION DEVICE

(71) Applicant: Fujitsu Telecom Networks Limited, Kawasaki-shi (JP)

(72) Inventors: Mika TOKUNAGA, Kawasaki-shi (JP); Makoto TAKAKUWA, Kawasaki-shi (JP)

(21) Appl. No.: 13/932,941

(22) Filed: Jul. 1, 2013

(30) Foreign Application Priority Data
Jul. 20, 2012 (JP) 2012-161784

(51) Int. Cl. H04L 12/26

(52) U.S. Cl. CPC H04L 43/50
USPC 370/252

(57) ABSTRACT

A communication device includes: a test frame generation unit configured to generate a test frame containing priority information and change the priority information for each test frame; a plurality of queues each for each of which a given priority of an input frame is defined; a queue extraction unit configured to extract the priority information of a test frame; a sorting unit configured to forward, when a test frame is input, the test frame to one of the plurality of queues in accordance with the priority information extracted by the queue extraction unit; and a test frame discarding unit configured to check normality of the test frame output from the queue and then discard the test frame.

### BACKGROUND OF THE INVENTION

1. Field of the Invention

The present invention relates to a communication device for transferring frames such as Ethernet (registered trademark) frames.

2. Description of the Related Art

Recently, the communication industry has turned to relatively inexpensive communication systems supported by the Ethernet technology from relatively expensive communication systems supported by the Synchronous Digital Hierarchy/Synchronous Optical NETwork) (SDH/SONET) technology. This is even true in large-capacity trunk communication circuits, i.e., so-called backbone circuits.

A major requirement in the current communication market is to make the latest information available at the requested time and by the requested amount instead of feeding information continuously. In other words, it is essential to monitor communication to ensure that frames flows properly regardless of when the information is fed or what information is fed.

Conventionally, there is known a technology for monitoring the normality of communication between communication devices by transferring a normality test frame (hereinafter, “test frame”) between communication devices (also referred to as “nodes”) connected via a network (e.g., patent document 1).
[patent document 1] JP7-235924

Meanwhile, in addition to monitoring the flow of frames between communication devices, there is a need to suitably monitor the normality of a frame transfer path in individual communication devices by causing a test frame to flow in the communication device periodically.

### SUMMARY OF THE INVENTION

The present invention addresses the aforementioned issue and a purpose thereof is to provide a technology capable of suitably monitor the normality of a frame transfer path in a communication device.

The communication device that addresses the aforementioned issue comprises: a test frame generation unit configured to generate a test frame containing priority information and change the priority information for each test frame; a plurality of queues each for each of which a given priority of an input frame is defined; a queue extraction unit configured to extract the priority information of a test frame; a sorting unit configured to forward, when a test frame is input, the test frame to one of the plurality of queues in accordance with the priority information extracted by the queue extraction unit; and a checking unit configured to check normality of the test frame output from the queue.

Optional combinations of the aforementioned constituting elements, and implementations of the invention in the form of apparatuses, methods, systems, programs, and recording mediums storing programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 illustrates a communication device according to an embodiment of the present invention;

FIGS. 2A-2C show exemplary formats of frames;

FIG. 3 shows the configuration of the transceiver;

FIG. 4 shows the configuration of the input processing unit;

FIG. 5 shows the data format of the input address table;

FIG. 6 shows the configuration of the traffic manager;

FIG. 7 shows the configuration of the output processing unit;

FIG. 8 shows a flow of checking the normality of the transceiver by the test frame;

FIG. 9 shows the communication device according to a first alternative embodiment of the present invention;

FIG. 10 shows a variation of the input processing unit; and

FIG. 11 shows the communication device according to a second alternative embodiment.

### DETAILED DESCRIPTION OF THE INVENTION

The invention will now be described by reference to the preferred embodiments. This does not intend to limit the scope of the present invention, but to exemplify the invention.

A description will now be given of embodiments of the present invention with reference to the drawings.

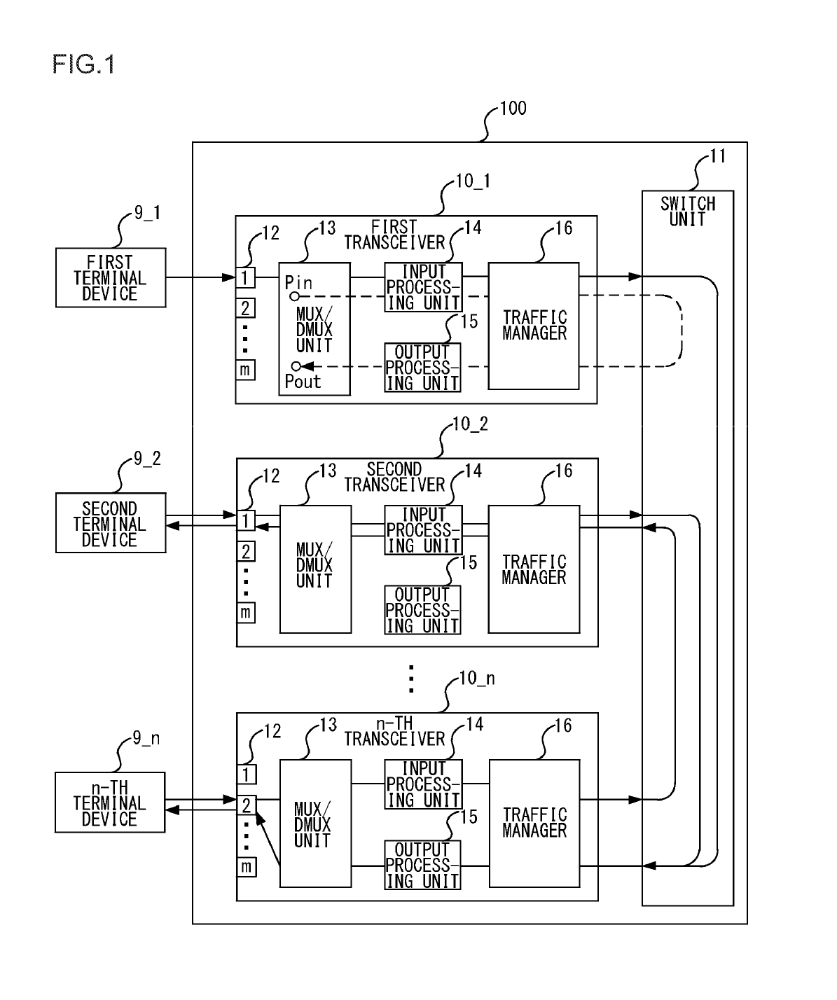

FIG. 1 illustrates a communication device 100 according to an embodiment of the present invention. The communication device 100 is a device for switching Ethernet frames received from other devices in accordance with destination information contained in the frames and relaying the frames to destination devices. In this embodiment, the communication device 100 processing Ethernet frames will be described by way of example. However, the example is non-limiting and the device may be adapted for Asynchronous Transfer Mode (ATM) cells.

The communication device 100 is provided with first through n-th transceivers 10_1-10_{—}n (n is an integral equal to or greater than 2), and a switch unit 11. In the following description, the first through n-th transceivers 10_1-10_{—}n may be generically referred to as “transceivers 10”.

The first through n-th transceivers 10_1-10_{—}n are connected to first through n-th terminal devices 9_1-9_n, respectively. In the following description, the first through n-th terminal devices 9_1-9_{—}n may be generically referred to as “terminal devices 9”. Each transceiver 10 transfers a user frame received from a terminal device 9 to other devices. Further, the switch unit 11 exchanges user frames between a plurality of transceivers 10. The transceiver 10 may not necessarily be connected to the terminal device 9 such as a personal computer but may be connected to another device such as a server device and a router.

Each transceiver 10 is provided with a first port through m-th ports 12_1-12_{—}m (m is an integer equal to or greater than 2), an MUX/DMUX unit 13, an input processing unit 14, an output processing unit 15, and a traffic manager 16. In the following description, the first through m-th ports 12_1-12_{—}m may be generically referred to as “ports 12”. The ports 12 correspond to individual communication circuits and include a communication cable connector such as an RJ-45 connector and a communication processing circuit provided with functionalities for the physical (PHY) layer and the Media Access Control (MAC) layer. The communication circuit is exemplified by a 1000BASE-T circuit, a 10 GBASE-T circuit, etc. defined by The Institute of Electrical and Electronics Engineers, Inc. (IEEE).

Referring to FIG. 1, arrows on solid lines indicate paths of user frames, and an arrow on the broken line indicates a path of a test frame. The term “user frame” refers to a frame generated in the terminal device 9, the server device, or the like and containing information transferred and received by the user. Meanwhile, the term “test frame” refers to a frame used to monitor the flow of frames in the communication device 100.

A user frame is input via the first port 12_1 of the first transceiver 10_1 and output to the switch unit 11 via the MUX/DMUX unit 13, the input processing unit 14, and the traffic manager 16. The switch unit 11 outputs the input user frame to the traffic manager 16 of the n-th transceiver 10_{—}n. The user frame is transferred from the second port 12_2 to the n-th terminal device 9_{—}n via the traffic manager 16, the output processing unit 15, and the MUX/DMUX unit 13.

Meanwhile, a test frame is generated at a point of generation Pin in the MUX/DMUX unit 13 and output to the switch unit 11 via the input processing unit 14 and the traffic manager 16. The switch unit 11 returns the input test frame and outputs the frame to the traffic manager 16. The test frame is output to the MUX/DMUX unit 13 via the traffic manager 16 and the output processing unit 15 and is terminated at a point of termination Pout in the MUX/DMUX unit 13.

While the test frame is transferred over the path described above, the test frame is used to test the memories provided in the input processing unit 14, the output processing unit 15, and the traffic manager 16. The input processing unit 14 processes ingress frames and the output processing unit 15 processes egress frames. The traffic manager 16 performs queuing according to the priority of the frame. The user frame and the test frame share a common transfer path in the communication device 100. The point of generation Pin and the point of termination Pout of the test frame may be provided in another external device instead of the transceiver 10 tested. This has an advantage of reducing the scale of hardware in the transceiver 10.

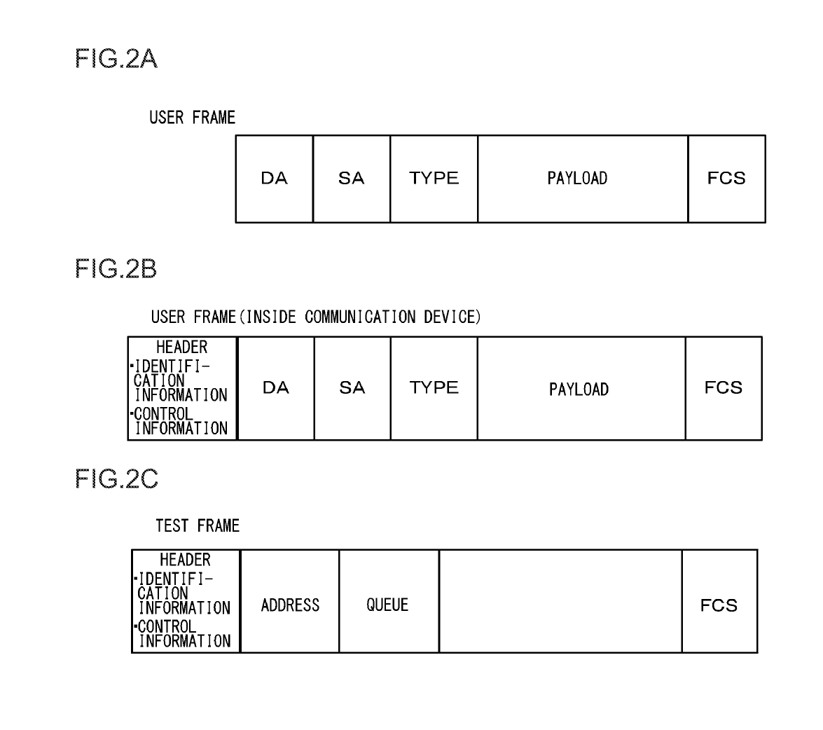

FIGS. 2A-2C show exemplary formats of frames. FIG. 2A shows a basic format of a user frame (Ethernet frame). The user frame is output from the terminal device 9 and input to the communication device 10. The user frame contains areas for Destination Address (DA), Source Address (SA), TYPE, Payload, and Frame Check Sequence (FCS). DA represents the MAC address of the destination device and SA represents the MAC address of the source device. TYPE represents the type of protocol such as Internet Protocol (IP). Payload represents information transferred and received by the frame. FCS represents information for detecting an error in the data for the frame.

FIG. 2B shows a basic format of a user frame in the communication device 100. The intra-device user frame is derived from adding a header to the above-described Ethernet frame. The header is added to and deleted from the user frame in the MUX/DMUX unit 13.

FIG. 2C shows a basic format of a test frame. The test frame is a frame transferred only inside the communication device 100. The format of a test frame is modeled after the format of the user frame. The test frame has a header at the beginning. The header of the test frame is generated concurrently with the body of the test frame at the point of generation Pin. The content of DA, SA, TYPE, and Payload of the test frame is non-limiting. For example, the content may be all “0”. As in the user frame, FCS contains a value calculated based on the values of the other areas.

In the embodiment, the test frame contains address information immediately following the header and contains queue information immediately following the address. The address information is for testing the normality of the input address table provided in the input processing unit 14 and the address table provided in the output processing unit 15. The queue information is for testing the normality of the queue provided in the traffic manager 16. In this embodiment, the address information is provided immediately following the header and the queue information is provided immediately following the address information as described above, but the position of the address information and the queue information in the frame is non-limiting.

The header contains identification information and various control information. The identification information is provided to distinguish between a user frame and a test frame. For example, the identification information of “0” indicates that the frame is a user frame, and the identification of “1” indicates that the frame is a test frame. The input processing unit 14, the output processing unit 15, and the traffic manager 16 refer to the identification information to distinguish between frames for the purpose of processing. Upon identifying the test frame by referring to the identification information, the switch unit 11 returns the test frame to the source transceiver 10 as described above (see the broken line in FIG. 1).

For example, the control information contains the identification number 1-n identifying the transceiver 10 to which the frame is destined, and the identification number 1-m identifying the port 12 in the transceiver 10 at the destination of transfer. The identification number 1-n of the transceiver 10 is appended by, for example, the input processing unit 14 to the header. The switch unit 11 refers to the identification number 1-n in the header to identify the transceiver 10 at the destination of transfer. The output processing unit 15 appends the identification number 1-m identifying the port 12 to the header, and the MUX/DMUX unit 13 refers to the identification number 1-m to identify the port 12 at the destination of transfer. As described above, the communication device 100 performs Multi-protocol Label Switching (MPLS).

The control information contains information related to the priority of the frame and information related to the output port. The traffic manager 16 refers to these items of information to perform Quality of Service (QoS) control.

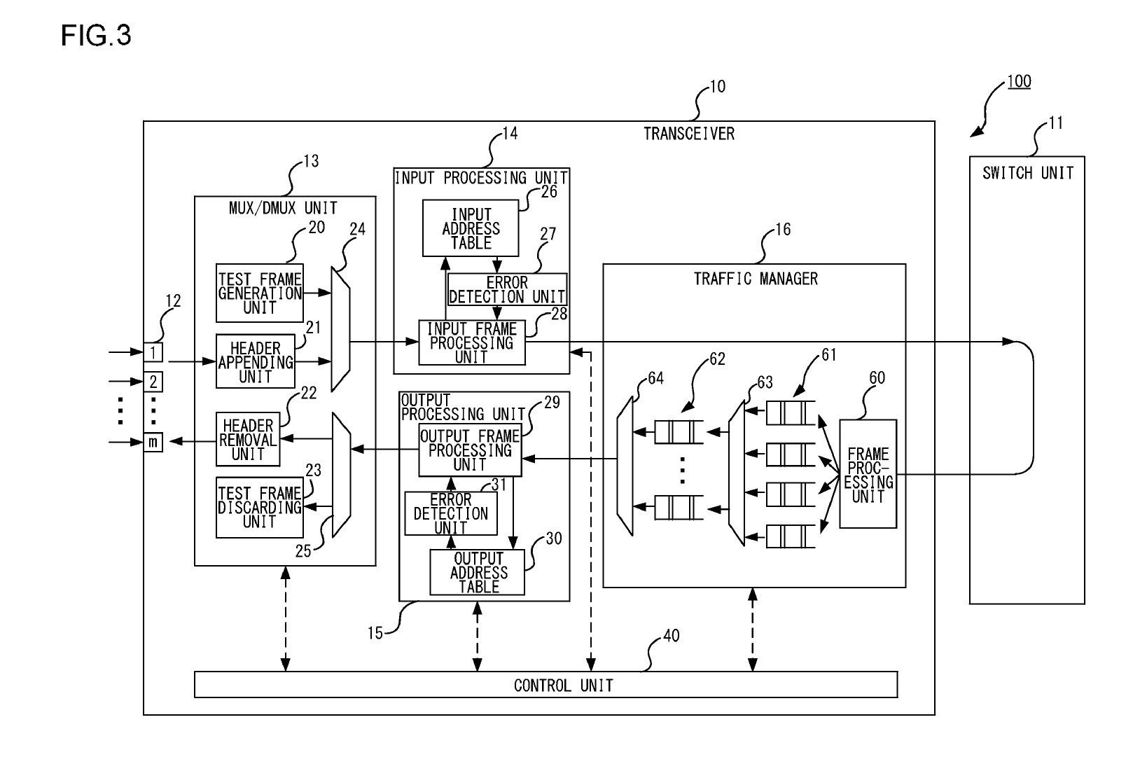

FIG. 3 shows the configuration of the transceiver 10. The transceiver 10 is provided with the MUX/DMUX unit 13, the input processing unit 14, the output processing unit 15, the traffic manager 16 and a control unit 40 for centrally controlling these functional units.

The MUX/DMUX unit 13 is provided with a test frame generation unit 20, a header appending unit 21, a header removal unit 22, a test frame discarding unit 23, a MUX processing unit 24, and a DMUX processing unit 25.

The header appending unit 21 and the header removal unit 22 are connected to the first through m-th ports 12_1-12_{—}m. The header appending unit 21 appends a header to the incoming Ethernet frame and outputs an intra-device user frame as shown in FIG. 2B.

The test frame generation unit 20 corresponds to the point of generation in shown in FIG. 1 and generates a test frame according to an instruction from the control unit 40. The test frame generation unit 20 generates a header and a frame check sequence (FCS) in addition to the body of a test frame. As described above, the test frame contains address information immediately following the header and contains queue information immediately following the address information.

In the embodiment, the test frame generation unit 20 determines the memory address of the input address table 26 and the output address table 30 tested and writes the determined address in the test frame as the address information. The input address table 26 and the output address table 30 are memories included in the input processing unit 14 and the output processing unit 15, respectively. The test frame generation unit 20 changes the address of the address of the memory tested for each test frame generated. The test frame generation unit 20 maintains a counter value for determining the address of the memory tested and changes the counter value each time the test frame is generated. The counter value may vary in increments of a fixed value. This allows the test frame generation unit 20 to vary the address information so as to cover the addresses in the memories exhaustively.

The test frame generation unit 20 determines a flow queue 61 and a port queue 62 tested and writes queue information in the test frame. The flow queues 61 and the port queues 62 are memories included in the traffic manager 16. Each of the queues 61 and 62 comprises a plurality of queues. The queue information includes priority information and output port information. The priority information designates which of the flow queues 61 the test frame should pass through. The output information designates which of the port queues 62 that the test frame should pass through. The path in the flow queues 61 and the port queues 62 that the test frame should pass through is designated based on the priority information and the output port information. The test frame generation unit 20 according to the embodiment changes the priority information and the output port information for each test frame generated. In this way, the path in the flow queues 61 and the port queues 62 that the test frame should pass through can be changed as desired.

The test frame generation unit 20 controls the timing of transfer of the test frame in accordance with the setting provided by the control unit 40. The timing of transfer may be defined to arrive at intervals of a certain period (1 ms, 10 ms, etc.).

The MUX processing unit 24 controls the output of the user frame from the header appending unit 21 to the input processing unit 14 and controls the output of the test frame from the test frame generation unit 20 to the input processing unit 14. In other words, the MUX processing unit 24 arbitrates the output of a plurality of user frames and test frames.

For example, the MUX processing unit 24 grants permission for an output buffer of the header appending unit 21 that maintains a pending output user frame to output the user frame according to a round robin algorithm. This allows the output buffers maintaining pending output user frames to output the user frames successively.

The test frame generated by the test frame generation unit 20 is transferred to the input processing unit 14 based on the priority lower than that of the user frame in order to avoid the band for the user frame from being heavily loaded. Therefore, where both a test frame and a user frame are pending in output queues, the MUX processing unit 24 outputs the user frame in preference to the test frame. Meanwhile, where there are no pending output user frames and only an output test frame is pending, the MUX processing unit 24 grants permission to the test frame generation unit 20 so as to output the test frame. The operation of the MUX processing unit 24 is not limited to the one described above and may output a test frame in accordance with the timing of transfer described above regardless of whether output user frames are pending.

Meanwhile, the DMUX processing unit 25 sorts a user frame and a test frame input from the output processing unit 15, outputting the user frame and the test frame to the head removal unit 22 and the test frame discarding unit 23, respectively. The DMUX processing unit 25 recognizes the test frame based on the identification information in the header and outputs the test frame to the test frame discarding unit 23. Further, the DMUX processing unit 25 recognizes the user frame based on the identification information in the header and outputs the user frame to the header removal unit 22.

The header removal unit 22 removes the header from the input user frame and outputs the user frame to the port 12 corresponding to the identification number 1-m contained in the control information in the header.

The test frame discarding unit 23 corresponding to the point of termination Pout shown in FIG. 1 and discards the test frame upon receiving the frame. Before discarding the test frame, the test frame discarding unit 23 tests the normality of the input test frame according to the FCS in the test frame and notifies the control unit 40 of the result.

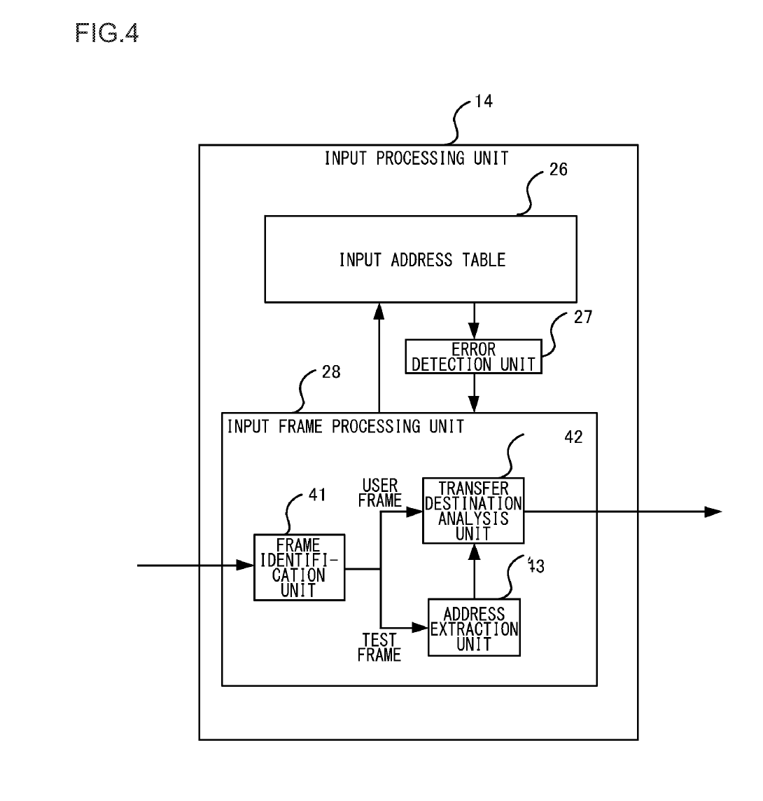

A description will now be given of the input processing unit 14. FIG. 4 shows the configuration of the input processing unit 14. As shown in FIG. 4, the input processing unit 14 is provided with the input address table 26, an error detection unit 27, and an input frame processing unit 28.

The input address table 26 is a memory subject to testing by the test frame. The input address table 26 maintains the destination addresses DA (the MAC addresses of the terminal devices 9 at the destination of transfer) of the user frame and the identification numbers 1-n of the transceivers 10, mapping the addresses DA to the numbers 1-n. The data in the input address table 26 are learned and built by, for example, flooding.

The input frame processing unit 28 is provided with a frame identification unit 41, a transfer destination analysis unit 42, and an address extraction unit 43.

The frame identification unit 41 identifies whether the input frame is a user frame or a test frame in accordance with the identification information contained in the header of the input frame. The frame identification unit 41 outputs the user frame to the transfer destination analysis unit 42 and outputs the test frame to the address extraction unit 43 in accordance with the result of identification.

The address extraction unit 43 analyzes the received test frame and extracts the address information contained in the test frame. The address extraction unit 43 has knowledge where in the test frame the address information is contained. Thus, the address extraction unit 43 outputs the test frame and the extracted address information to the transfer destination analysis unit 42.

Upon receipt of the user frame from the frame identification unit 41, the transfer destination analysis unit 42 refers to the input address table 26 and identifies the identification number 1-n of the transceiver 10 based on the destination address DA of the user frame. The transfer destination analysis unit 42 reads the identification number 1-n of the identified transceiver 10 via the error detection unit 27. The transfer destination analysis unit 42 writes the read identification number 1-n in the header of the user frame and transmits the user frame to the traffic manager 16.

Meanwhile, upon receipt of the test frame and the address information from the address extraction unit 43, the transfer destination analysis unit 42 accesses the input address table 26 and reads the data stored in the address via the error detection unit 27. The transfer destination analysis unit 42 transfers the test frame to the traffic manager 16 without writing the read data in the header of the test frame.

The error detection unit 27 detects an error in the data read from the input address table 26 responsive to the access by the transfer destination analysis unit 42. Error detection is done based on error detection information appended to the data. The error detection information is exemplified by an Error Check Code (ECC) but is non-limiting. Upon detection of a data error, the error detection unit 27 outputs an error notification to the control unit 40.

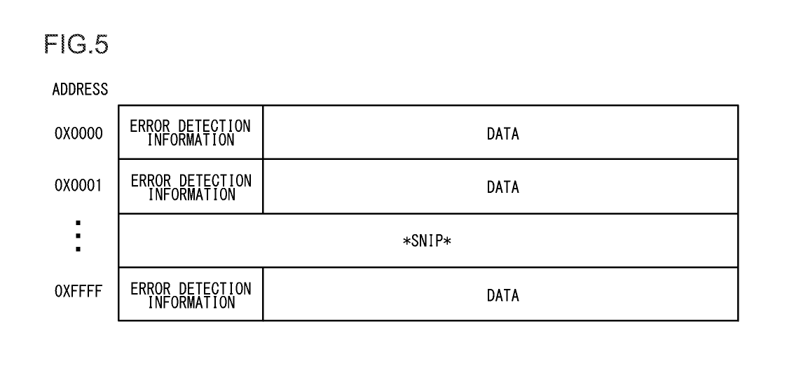

FIG. 5 shows the data format of the input address table 26. The input address table 26 stores the error detection information and data for each address. The addresses values shown in FIG. 5 are by way of example only. For example, ECC may be used in the error information. The data maps the transfer destination address DA of the user frame to the identification number 1-n of the transceiver 10.

As described above, the test frame generation unit 20 changes the address information for each test frame. Therefore, by repeating the process of extracting the address information contained in the received test frame and reading the data at that address, the data can be read exhaustively from the addresses in the input address table 26 and checked by the error detection unit 27.

Thus, according to the communication device 100 of the embodiment, the data associated with the identification number of the unused transceiver 10, i.e., the data for the addresses not so often accessed normally can be read and tested. In normal operation, only the data in the input address table 26 that is mapped to the transfer destination address DA of the user frame is read. For this reason, the data associated with the identification number of the unused transceiver 10, i.e. the data for the address not so often accessed normally may be identified to contain an error only when the user frame destined to the relevant transceiver 10 is received. Therefore, it is useful to detect an error in the data for the address not so often accessed normally in advance of the reception of the user frame.

As described with reference to FIG. 1 the user frame output from the input processing unit 14 is output to the switch unit 11 via the traffic manager 16. The switch unit 11 identifies the transceiver 10 to which the user frame should be transferred by referring to the identification number 1-n written in the header of the input user frame, and transfers the user frame to the identified transceiver 10.

Further, as described with reference to FIG. 1, the test frame output from the input processing unit 14 is returned by the switch unit 11 and input to the traffic manager 16 of the originating transceiver 10.

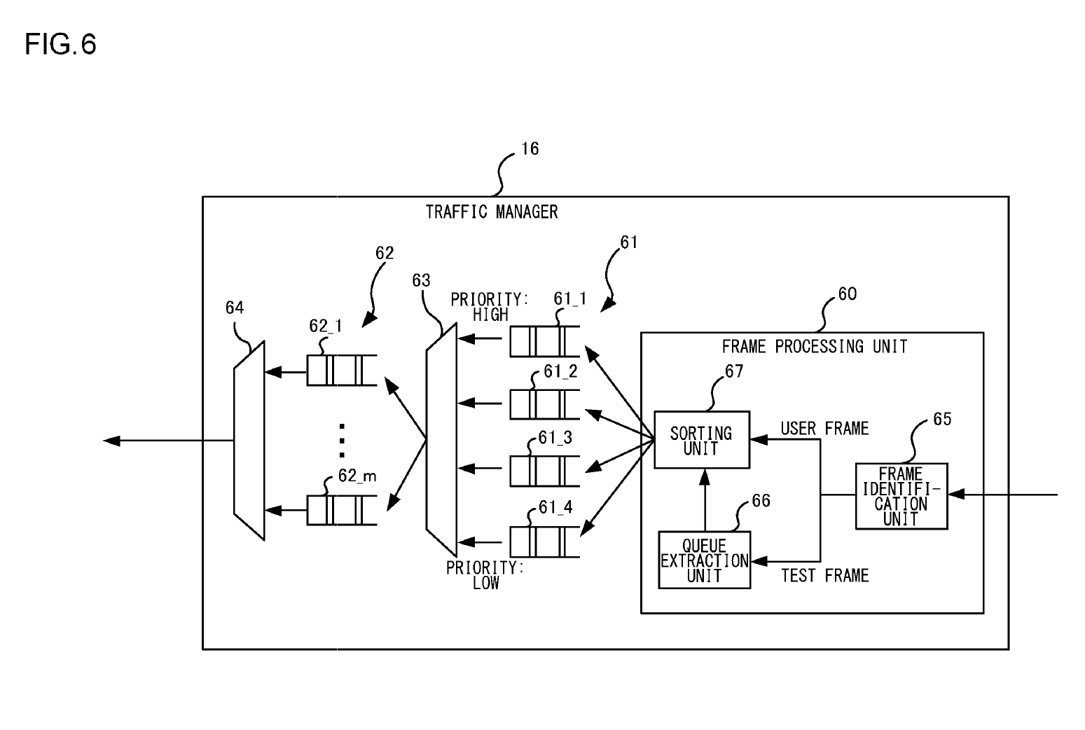

A description will now be given of the traffic manager 16. FIG. 6 shows the configuration of the traffic manager 16. The traffic manager 16 queues frames according to the priority of the frame. As shown in FIG. 6, the traffic manager 16 is provided with a frame processing unit 60, the flow queues 61, the port queues 62, a first selector 63, and a second selector 64.

The frame processing unit 60 is provided with a frame identification unit 65, a queue extraction unit 66, and a sorting unit 67. The flow queues 61 include a first flow queue 61_{—1, a second flow queue 61}_2, a third flow queue 61_3, and a fourth flow queue 61_4. The port queues 62 include first through m-th port queues 62_1-62_{—}m.

The frame identification unit 65 distinguishes whether an input frame is a user frame or a test frame by referring to the identification information contained in the header of the input frame. The frame identification unit 65 outputs the user frame to the sorting unit 67 and outputs the test frame to the queue extraction unit 66 in accordance with the result of identification.

Upon receipt of the test frame, the queue extraction unit 66 analyzes the test frame so as to extract the queue information contained in the test frame. As described above, the queue information contains priority information and output port information. The queue extraction unit 66 has knowledge where in the test frame the queue information is contained. Thus, the queue extraction unit 66 outputs the test frame and the extracted queue information to the sorting unit 67.

Upon receipt of the user frame from the frame identification unit 65, the sorting unit 67 sorts the user frame in accordance with the priority information contained in the header of the user frame, forwarding the user frame to one of the first flow queue 61_1, the second flow queue 61_2, the third flow queue 61_3, and the fourth flow queue 61_4. The first flow queue 61_1 receives a frame with the highest priority, followed by the second flow queue 61_2 and the third flow queue 61_3. The fourth flow queue 61_4 receives a frame with the lowest priority.

The user frame input to the flow queues 61 joins an output queue. The first selector 63 extracts the user frame pending in the flow queues 61 according to the priority of the flow queue. The first selector 63 extracts the user frame stored in one of the flow queues 61 with a higher priority in preference over those of the other queues.

The first selector 63 outputs the user frame to one of the first through m-th port queues 62_1-62_{—}m in accordance with the output port information contained in the header of the user frame. The user frame input to the port queues 62 joins an output queue. The second selector 64 extracts the user frame pending in the port queues 62 and outputs the user frame to the output processing unit 15.

Upon receipt of the test frame and the queue information from the queue extraction unit 66, the sorting unit 67 sorts the test frame in accordance with the priority information contained in the queue information, forwarding the test frame to one of the first flow queue 61_1, the second flow queue 61_2, the third flow queue 61_3, and the fourth flow queue 61_4. For example, if the highest priority is designated, the sorting unit 67 outputs the test frame to the first flow queue 61_1. If the second highest priority is designated, the sorting unit 67 outputs the test frame to the second flow queue 61_2.

Subsequently, the first selector 63 extracts the test frame pending in the flow queues 61 according to the priority of the flow queue. The process is the same as that of the user frame. The first selector 63 outputs the test frame to one of the first through m-th port queues 62_1-62_{—}m in accordance with the output port information contained in queue information. The test frame input to the port queues 62 joins an output queue. The second selector 64 extracts the test frame pending in the port queues 62 and outputs the test frame to the output processing unit 15.

As described above, the test frame generation unit 20 changes the queue information, i.e., the priority information and output port information, for each test frame. Therefore, the communication device 100 according to the embodiment is capable of allowing the test frame to pass through different flow queues 61 and different port queues 62. The normality of the test frame that passed through the flow queues 61 and the port queues 62 is tested by the test frame discarding unit 23 of the MUX/DMUX unit 13.

Thus, according to the communication device 100 of the embodiment, the normality of those of the flow queues 61 and the port queues 62 that are unused can be tested. Where only the user frame with the highest priority is delivered in a normal operation, the normality of the transfer path involving the first flow queues 61_1 can be checked, but the normality of the second flow queue 61_2, the third flow queue 61_3, and the fourth flow queue 61_4, which the user frame does not pass through, cannot be checked. For this reason, if an abnormality occurs in the second flow queue 61_2, the third flow queue 61_3, or the fourth flow queue 61_4, the abnormality can be detected only when the user frame passing through in any of these flow queues is received. This will result in a lost user frame and so is not favorable.

Since the test frame is normally assigned a low priority, mere delivery of the test frame within the communication device results in the test frame being only capable of passing through the queue with the lowest priority, i.e., the test frame can only pass through the fourth flow queue 61_4. Therefore, the flow in the other queues, e.g., the second flow queue 61_2 and the third flow queue 61_3, cannot be tested.

The communication device 100 according to the embodiment is configured to provide the test frame with queue information to change the priority and the output port of the test frame depending on the test frame. The frame processing unit 60 of the traffic manager 16 is configured to extract the queue information so as to allow test frames to pass through different queues as determined by the priority and the output port of the test frame. This allows a variety of paths of queues to be tested exhaustively so that abnormality in the flow queues 61 and the port queues 62 can be detected early. Accordingly, loss etc. of user frames is avoided or, at least, mitigated.

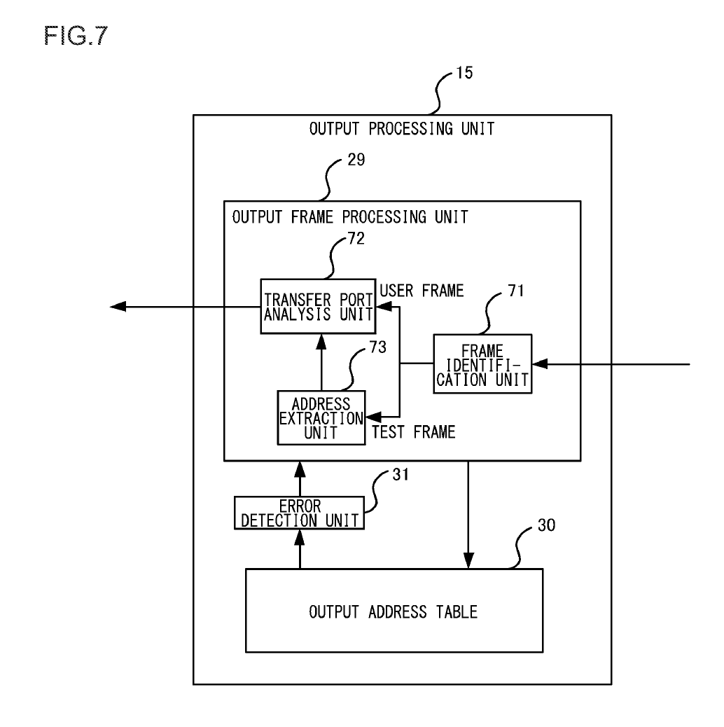

A description will now be given of the output processing unit 15. FIG. 7 shows the configuration of the output processing unit 15. As shown in FIG. 7, the output processing unit 15 is provided with the output address table 30, an error detection unit 31, and an output frame processing unit 29.

The output address table 30 is a memory subject to testing by the test frame. The output address table 30 maintains the destination addresses DA of the user frame and the identification numbers 1-m of transfer destination ports 12, mapping the addresses DA to the numbers 1-m. The data in the output address table 30 are learned and built by, for example, flooding.

The output frame processing unit 29 is provided with a frame identification unit 71, a transfer port analysis unit 72, and an address extraction unit 73.

The frame identification unit 71 identifies whether the input frame is a user frame or a test frame in accordance with the identification information contained in the header of the input frame. The frame identification unit 71 outputs the user frame to the transfer port analysis unit 72 and outputs the test frame to the address extraction unit 73 in accordance with the result of identification.

The address extraction unit 73 analyzes the received test frame and extracts the address information contained in the test frame. The address extraction unit 73 has knowledge where in the test frame the address information is contained. Thus, the address extraction unit 73 outputs the test frame and the extracted address information to the transfer port analysis unit 72.

Upon receipt of the user frame from the frame identification unit 71, the transfer destination analysis unit 72 refers to the output address table 30 and identifies the identification number 1-m of the transfer destination port 12 based on the destination address DA of the user frame. The transfer port analysis unit 72 reads the identified transfer destination port via the error detection unit 31. The transfer port analysis unit 72 writes the read identification number 1-m in the header of the user frame and transmits the user frame to the DMUX processing unit 25 of the MUX/DMUX unit 13.

Meanwhile, upon receipt of the test frame and the address information from the address extraction unit 73, the transfer port analysis unit 72 accesses the output address table 30 and reads the data stored in the address via the error detection unit 31. The transfer port analysis unit 72 transfers the test frame to the DMUX processing unit 25 of the MUX/DMUX unit 13 without writing the read data in the header of the test frame.

The error detection unit 31 detects an error in the data read from the output address table 30 responsive to the access by the transfer port analysis unit 72. Error detection is done based on error detection information appended to the data. The error detection information is exemplified by an Error Check Code (ECC) but is non-limiting. Upon detection of a data error, the error detection unit 31 outputs an error notification to the control unit 40.

Therefore, as in the case of the input processing unit 14, the data can be read exhaustively from the addresses in the output address table 30 of the output processing unit 15 and checked by the error detection unit 31. Thus, an error in the data for the addresses not so often accessed normally can be detected early in advance of the reception of the user frame.

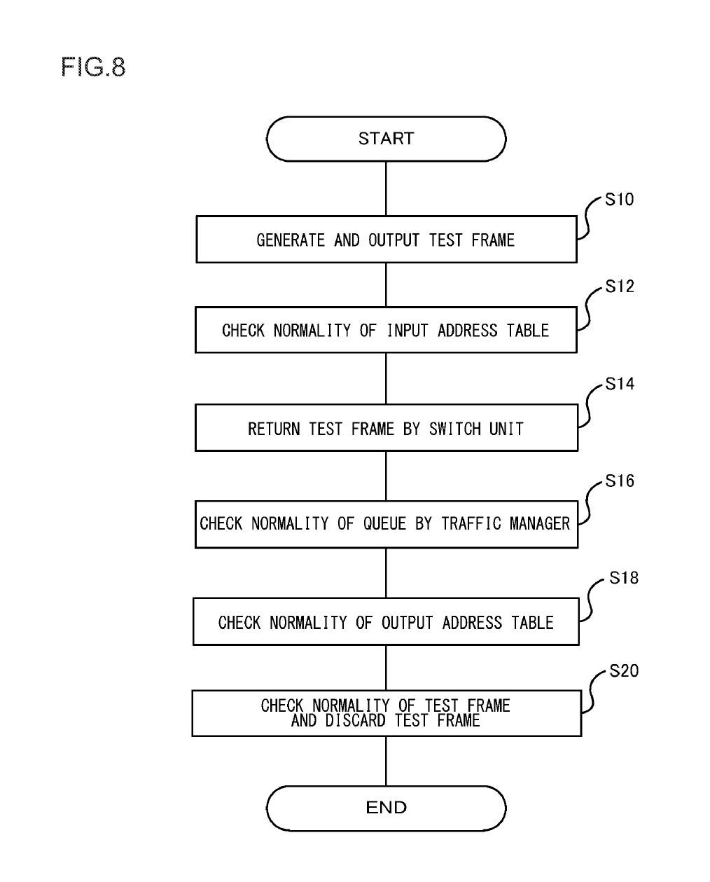

FIG. 8 shows a flow of checking the normality of the transceiver 10 by the test frame.

Initially, the test frame generation unit 20 of the MUX/DMUX unit 13 generates a test frame in accordance with an instruction of the control information 40 and outputs the generated frame to the input processing unit 14 (S10). The test frame contains address information immediately following the header and contains queue information immediately following the address. The address information and the queue information are changed for each test frame.

Upon receipt of the test frame, the input frame processing unit 28 of the input processing unit 14 tests the normality of the input address table 26 (S12). The error detection unit 27 detects an error in the data read from the input address table 26. Upon detection of a data error, the error detection unit 27 outputs a data error notification to the control unit 40. After testing the table for a possible error, the input frame processing unit 28 forwards the test frame to the switch unit 11.

Upon identifying the input frame as a test frame, the switch unit 11 returns the test frame to the traffic manager 16 of the transceiver 10 at the source of output (S14).

Upon receipt of the test frame, the traffic manager 16 tests the flow queues 61 and the port queues 62 for normality (S16). Abnormality in the flow queues 61 or the port queues 62 is detected by the test frame discarding unit 23 of the MUX/DMUX unit 13. The test frame output from the traffic manager 16 is output to the output frame processing unit 29 of the output processing unit 15.

Upon receipt of the test frame, the output frame processing unit 29 of the output processing unit 15 tests the normality of the output address table 30 (S18). The error detection unit 30 detects an error in the data read from the output address table 30. Upon detection of a data error, the error detection unit 31 outputs a data error notification to the control unit 40. After testing the table for a possible error, the output processing unit 29 forwards the test frame to the MUX/DMUX unit 13.

Upon identifying the input frame as a test frame, the DMUX processing unit 25 of the MUX/DMUX unit 13 outputs the test frame to test frame discarding unit 23. The test frame discarding unit 23 tests the normality of the input test frame according to the FCS and discards the test frame subsequently (S20). If the test frame contains abnormality, the test frame discarding unit 23 notifies the control unit 40 accordingly.

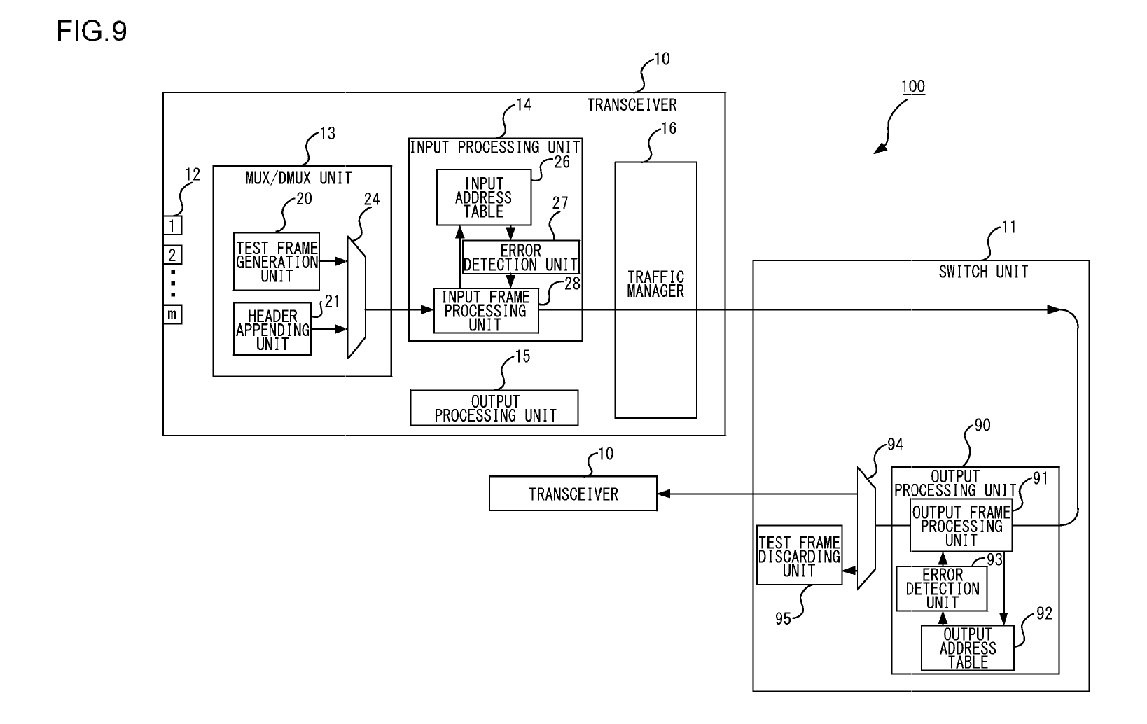

FIG. 9 shows the communication device 100 according to a first alternative embodiment of the present invention. In the communication device 100 shown in FIGS. 3 and 9, like numerals represent like components and the description will not be repeated. In FIG. 9, illustration of some of the internal configuration including the MUX/DMUX unit 13, the output processing unit 15, the traffic manager 16, etc. is omitted.

In this embodiment, the switch unit 11 is provided with an output processing unit 90, a DMUX processing unit 94, and a test frame discarding unit 95. The output processing unit 90 is provided with an output frame processing unit 91, an error detection unit 93, and an output address table 92.

In this embodiment, the test frame transferred from the test frame generation unit 20 of the transceiver 10 is input to the switch unit 11 via the input processing unit 14 and the traffic manager 16. In the communication device 100 shown in FIG. 3, the switch unit 11 returns the input test frame to the source transceiver 10. In this embodiment, however, the switch unit 11 does not return the test frame but transfers the test frame to another transceiver 10. The test frame is input to the output processing unit 90 before being transferred to the other transceiver 10. As in the case of the test frame, the user frame is also input to the output processing unit 90.

The operation of the functional units of the output processing unit 90 is substantially identical to that of the output processing unit 15 in the transceiver 10 described with reference to FIG. 7. The test frame is used to test the addresses in the output address table 92 for a possible error.

The DMUX processing unit 94 identifies whether the frame input from the output processing unit 90 is a test frame or a user frame. If the input frame is a test frame, the DMUX processing unit 94 outputs the frame to the test frame discarding unit 95. On the other hand, if the input frame is a user frame, the DMUX processing unit 94 outputs the frame to the transceiver 10 in accordance with the identification number 1-n of the transceiver 10 written in the header.

Upon receipt of the test frame, the test frame discarding unit 95 discards the frame. Before discarding the test frame, the test frame discarding unit 95 tests the normality of the input test frame according to the FCS in the test frame and notifies the control unit of the result.

Since the switch unit 11 returns the test frame according to the embodiment shown in FIG. 3, the path in which the switch unit 11 returns the frame can be tested for normality. However, those paths in which the frame is not returned by the switch unit 11 cannot be tested for normality. According to the communication device 100 of the first alternative embodiment, the output processing unit 90 is provided in the switch unit 11 so that the flow of all generated test frames can be tested regardless of whether the switch unit 11 returns the test frame or not.

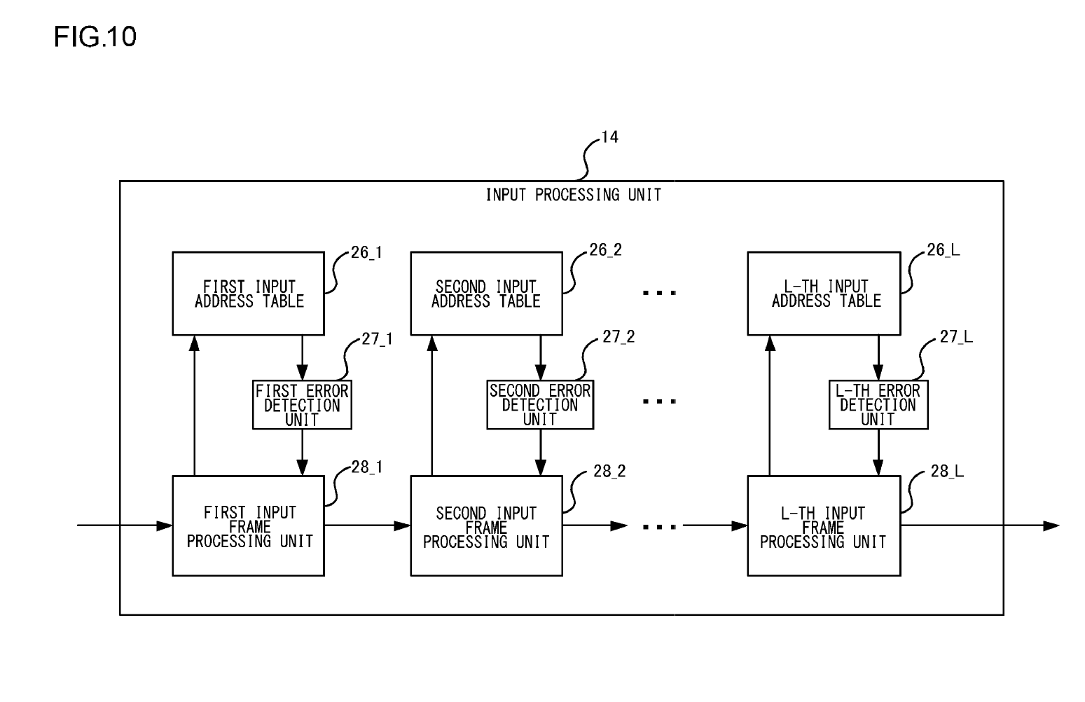

FIG. 10 shows a variation of the input processing unit 14. As shown in FIG. 10, the input processing unit 14 according to the variation is provided with first through L-th input address tables 26_1-26_L, first through L-th error detection units 27_1-27_L, and first through L-th input frame processing units 28_1-28_L (L is an integer equal to or greater than 2). Like the input frame processing unit 28 shown in FIG. 4, each of the first through L-th input frame processing units 28_1-28_L is provided with a frame identification unit, a transfer destination analysis unit, and an address extraction unit (not shown).

In the input processing unit 14 according to the variation, each of the first through L-th input address tables 26_1-26_L is preconfigured to test respective addresses. For example, the first table 26_1 may be configured to test the lowermost two bits of the address, and the second address table 26_2 may be configured to test the lowermost three bits of the address.

The frame is input from the MUX/DMUX unit 13 to the first input frame processing unit 28_1. The frame identification unit of the first input frame processing unit 28_1 identifies whether the frame is a test frame or a user frame. The user frame is transferred to the transfer destination analysis unit and the test frame is transferred to the address extraction unit. The address extraction unit of the first input frame processing unit 28_1 extracts only those bits of the address information in the test frame that are defined in the first input address table 26_1. For example, if the first input address table 26_1 is configured to test the lowermost two bits of the address, the address extraction unit extracts the lowermost two bits from the address information. The address extraction unit outputs the test frame and the extracted address information to the transfer destination analysis unit. The transfer destination analysis unit reads, for example, the data corresponding to the lowermost two bits via the first error detection unit 27_1. Upon detection of an error in the read data, the first error detection unit 27_1 outputs a data error notification to the control unit. After reading the data, the transfer destination analysis unit outputs the test frame to the second input frame processing unit 28_2.

The second input frame processing unit 28_2 performs a similar process. For example, if the second input address table 26_1 is configured to test the lowermost three bits of the address, the address extraction unit of the second input frame processing unit 28_2 extracts the lowermost three bits from the address information. The transfer destination analysis unit reads the data corresponding to the lowermost three bits via the second error detection unit 27_2. Upon detection of an error in the read data, the second error detection unit 27_2 outputs a data error notification to the control unit. After reading the data, the transfer destination analysis unit outputs the test frame to the third input frame processing unit (not shown).

Thus, by verifying the address in blocks, the input processing unit 14 according to the variation is capable of identifying the location of an error in the input address table efficiently.

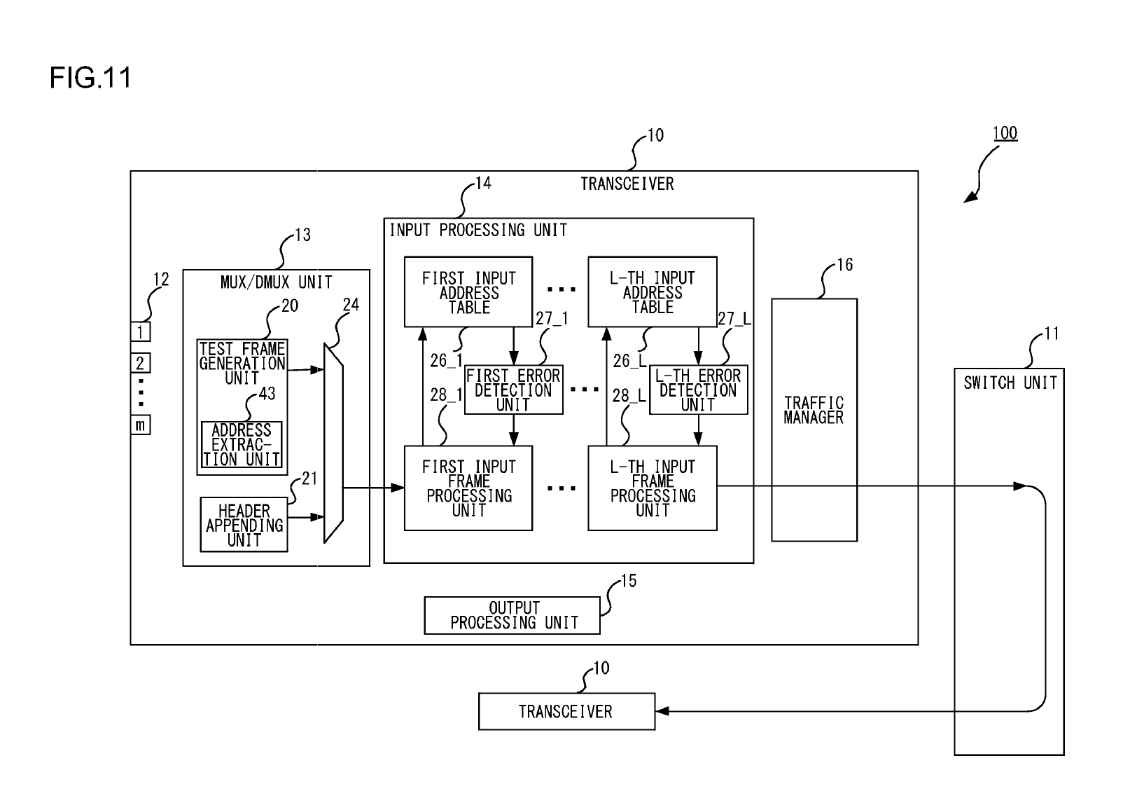

FIG. 11 shows the communication device 100 according to a second alternative embodiment. Those elements in FIG. 11 that are identical to or corresponding to those in the foregoing embodiments are denoted by like numerals and the description will not be repeated.

The communication device 100 according to the second alternative embodiment is provided with the input processing unit 14 shown in FIG. 10. According to this embodiment, the address extraction unit 43 is provided in the test frame generation unit 20 of the MUX/DMUX unit 13. Each of the input frame processing units in the input processing unit 14 is provided with the frame identification unit and the transfer destination analysis unit 42 but is not provided with the address extraction unit.

It will be assumed in the second alternative embodiment that the test frame generation unit 20 generates a test frame having 8-bit address information “abcdefgh”. In this case, the address extraction unit 43 extracts the address information from the generated test frame. Those bits of the address information that are extracted are defined externally. For example, given that blocks of three bits are successively extracted from the lowermost bit, “fgh”, “cde”, and “0ab” are extracted. Subsequently, the test frame generation unit 20 replaces those bits of the address information other than the extracted bits by “0” and transmits the resultant bits as a test frame. For example, the test frame generation unit 20 transmits a test frame 1 containing “00000fgh” as address information, a test frame 2 containing “00cde000” as address information, and a test frame 3 containing “ab000000” as address information. As described above, a test frame, which should originally be transmitted as one frame, is transmitted as a plurality of frames (three, in the above example) by extracting address information.

According to the communication device 100 of the embodiment, it is not necessary to provide the address extraction unit in each of the first through L-th input frame processing units 28_1-28_L by providing the address extraction unit 43 in the test frame generation unit 20. Consequently, the circuit scale can be reduced.

Described above is an explanation based on an exemplary embodiment. The embodiment is intended to be illustrative only and it will be obvious to those skilled in the art that various modifications to constituting elements and processes could be developed and that such modifications are also within the scope of the present invention.

What is claimed is:

1. A communication device comprising:
a test frame generation unit configured to generate a test frame containing priority information and change the priority information for each test frame;
a plurality of queues each for each of which a given priority of an input frame is defined;
a queue extraction unit configured to extract the priority information of a test frame;
a sorting unit configured to forward, when a test frame is input, the test frame to one of the plurality of queues in accordance with the priority information extracted by the queue extraction unit; and
a checking unit configured to check normality of the test frame output from the queue.

2. The communication device according to claim 1,
wherein the test frame generation unit adds identification information indicating identity of a test frame to a generated test frame.

3. The communication device according to claim 2, further comprising:
a frame identification unit configured to identify whether an input frame is a test frame or a user frame,
wherein the frame identification unit outputs the test frame to the queue extraction unit and outputs the user frame to the sorting unit.

4. The communication device according to claim 1, further comprising:
an address table accessed while a user frame is being processed;
a frame processing unit configured to access the address table when a test frame is received; and
an error detection unit configured to detect an error in data read from the address table responsive to the access by the frame processing unit.

5. The communication device according to claim 4,
wherein, in generating a test frame, the test frame generation unit adds address information indicating an address in the address table subject to checking to the test frame and changes the address information for each test frame,
wherein the frame processing unit comprises:
an address extraction unit configured to extract the address information in the test frame; and
an analysis unit configured to access the address table when a test frame is input and read data from the address table via the error detection unit in accordance with the extracted address information.

6. The communication device according to claim 1, further comprising:
a discarding unit configured to discard the test frame received.
